(19) United States
(12) Patent Application Publication
(10) Pub. No.: US 2024/0112123 A1
(43) Pub. Date: Apr. 4, 2024

(54) METHODS AND SYSTEMS FOR ANALYZING ORGANIZATIONAL COMPLIANCE

(71) Applicant: KONINKLIJKE PHILIPS N.V., EINDHOVEN (NL)

(72) Inventor: Umut Yesilmen, Boeblingen (DE)

(21) Appl. No.: 18/275,631

(22) PCT Filed: Jan. 24, 2022
(86) PCT No.: PCT/EP2022/051448

§ 371 Date: Aug. 3, 2023

Related U.S. Application Data
(60) Provisional application No. 63/146,029, filed on Feb. 5, 2021.

(51) Int. Cl. G06Q 10/0639; G06F 40/205; G06Q 10/0633

(52) U.S. Cl. CPC G06Q 10/06395; G06F 40/205; G06Q 10/0633

(57) ABSTRACT

A method (100) for managing an organization's compliance, comprising: (i) receiving (120) information about the organization's assets; (ii) receiving (130) a compliance requirement for a business facet of the organization; (iii) generating (140), from the compliance requirement, one or more of a rule and a workflow; (iv) parsing (150) each of the assets into a parsed asset; (v) analyzing (160) the business facet; (vi) identifying (170) one or more lack of compliance issues based on the analysis, wherein a lack of compliance issue comprises a determination that the business asset fails to utilize the asset according to the rule and/or workflow; (vii) prioritizing (180), when multiple lack of compliance issues are identified, the multiple lack of compliance issues into a prioritized list based on one or more prioritization rules; and (viii) reporting (190) the one or more lack of compliance issues for the business facet to a user via a user interface.

### FIELD OF THE DISCLOSURE

The present disclosure is directed generally to methods and systems for managing an organization's compliance using a compliance management system.

### BACKGROUND

Companies operating in highly-regulated environments face substantial challenges, and thus significant workload, to ensure organizational compliance. The challenge is even larger when the company is working on complex technological products. All employees must be trained, must follow well-defined work instructions, and must always act responsibly to avoid introducing any non-compliance issues which can harm the company's prestige, cause financial loss, or cause even worse consequences. Competition in the marketplace also forces companies to move quickly, update their portfolio rapidly, and grow steadily. When all these dynamics are combined, it raises the associated risks and compliance issues are inevitable.

In many organizations, sufficient compliance means that throughput is dependent on headcount. There can be many functions that require concentration and time. When compliance workload increases (e.g. due to a critical quality issue, due to a new regulation, etc.), it becomes necessary to hire new employees. This may not be optimal, as it is expensive and it is becoming increasingly difficult to find employees with the necessary skill.

A common strategy to lower risk and support compliance efforts is the observation of patterns, discovering bottlenecks and problems, and identifying or prioritizing applicable solutions. One of the solutions for these issues is “expert systems,” computer systems that facilitate a decision making process using human-defined rules. However, existing expert systems are not designed to ensure compliance with a wide variety of different compliance requirements, including internal workflows and processes, industry standards, and legal regulations, among other compliance requirements.

### SUMMARY OF THE DISCLOSURE

Accordingly, there is a continued need in the art for methods and systems that ensure adherence to a wide variety of different compliance requirements while minimizing errors and enabling monitoring of organizational assets.

The present disclosure is directed to inventive methods and systems for a compliance management process. Various embodiments and implementations herein are directed to a method and system configured to manage or monitor an organization's compliance with a variety of compliance requirements. The compliance management system receives information about the organization's intangible assets, which can be one of a wide variety of different types of assets. The system receives a compliance requirement for a business facet of the organization. The business facet can be a product, process, sale, or any of a wide variety of business facets. The compliance requirement can be a workflow requirement, regulatory requirement, standard requirement, best practice requirement, and rule requirement for the business facet, among many other types of compliance requirements. The business facet utilizes one or more of the assets for completion. The system generates, from the received compliance requirement, one or more of a rule and a workflow. The system parses, using an asset parsing template of the compliance management system, each of the one or more assets into a parsed asset. The compliance management system uses a compliance engine to analyze the business facet, where analyzing comprises comparing the business facet to the received compliance requirement using (1) one or more of the parsed assets and (2) the rule and/or workflow to determine whether the business facet utilizes the asset according to the rule and/or workflow. The system identifies one or more lack of compliance issues based on the analysis. A lack of compliance issue comprises a determination by the compliance engine that the business asset fails to utilize the asset according to the rule and/or workflow and thus fails to satisfy the received compliance requirement. The system prioritizes the multiple lack of compliance issues into a prioritized list based on one or more prioritization rules, when multiple lack of compliance issues are identified, and reports the one or more lack of compliance issues for the business facet to a user via a user interface.

Generally, in example one, a method for managing an organization's compliance using a compliance management system is provided. The method includes: (i) receiving information about one or more of the organization's assets; (ii) receiving a compliance requirement for a business facet of the organization, wherein the compliance requirement comprises one or more of a workflow requirement, regulatory requirement, standard requirement, best practice requirement, and rule requirement for the business facet, and wherein the business facet utilizes one or more of the assets for completion; (iii) generating, from the received compliance requirement, one or more of a rule and a workflow; (iv) parsing, using an asset parsing template of the compliance management system, each of the one or more assets into a parsed asset; (v) analyzing, using a compliance engine, the business facet, wherein analyzing comprises comparing the business facet to the received compliance requirement using (1) one or more of the parsed assets and (2) the rule and/or workflow to determine whether the business facet utilizes the asset according to the rule and/or workflow; (vi) identifying one or more lack of compliance issues based on the analysis, wherein a lack of compliance issue comprises a determination by the compliance engine that the business asset fails to utilize the asset according to the rule and/or workflow and thus fails to satisfy the received compliance requirement; (vii) prioritizing, when multiple lack of compliance issues are identified, the multiple lack of compliance issues into a prioritized list based on one or more prioritization rules; and (viii) reporting the one or more lack of compliance issues for the business facet to a user via a user interface.

In embodiments, example one may be combined with example two, wherein the compliance engine comprises a text analyzer configured to facilitate parsing of the one or more assets into a parsed asset.

In embodiments, examples one or two may be combined with example three, wherein the compliance engine comprises an inference engine configured to facilitate the analysis of the business facet.

In embodiments, examples one, two, or three may be combined with example four, wherein an identified lack of compliance issue comprises a warning that one or more of the received workflow requirement, regulatory requirement, standard requirement, best practice requirement, and rule requirement are not met.

In embodiments, examples one, two, three, or four may be combined with example five, wherein the method further comprises the step of generating, based on the identified one or more lack of compliance issues, a recommendation for correcting a lack of compliance issue.

In embodiments, examples one, two, three, four, or five may be combined with example six, wherein the asset comprises one or more of a user requirements, service initiation document, compatibility matrix, project plan, service delivery plan, product specification, customer feedback, service delivery plan, traceability matrix, supplier agreement, verification test, source code, purchase order, and checklist.

In embodiments, examples one, two, three, four, five, or six may be combined with example seven, wherein the compliance requirements comprise one or more user-defined rules.

In embodiments, examples one, two, three, four, five, six, or seven may be combined with example eight, wherein prioritizing multiple lack of compliance issues into a prioritized list based on one or more prioritization rules comprises weighing one or more of the lack of compliance issues.

Generally, in example nine, a compliance management system for an organization is provided. The system includes a plurality of organizational assets; a plurality of compliance requirements for a business facet of the organization, wherein the compliance requirement comprises one or more of a workflow requirement, regulatory requirement, standard requirement, best practice requirement, and rule requirement for the business facet, and wherein the business facet utilizes one or more of the assets for completion; and a processor configured to: (i) generate, from the received compliance requirement, one or more of a rule and a workflow; (ii) parse, using an asset parsing template of the compliance management system, each of the one or more assets into a parsed asset; (iii) analyze, using a compliance engine, the business facet, wherein analyzing comprises comparing the business facet to the received compliance requirement using (1) one or more of the parsed assets and (2) the rule and/or workflow to determine whether the business facet utilizes the asset according to the rule and/or workflow; (iv) identify one or more lack of compliance issues based on the analysis, wherein a lack of compliance issue comprises a determination by the compliance engine that the business asset fails to utilize the asset according to the rule and/or workflow and thus fails to satisfy the received compliance requirement; (v) prioritize, when multiple lack of compliance issues are identified, the multiple lack of compliance issues into a prioritized list based on one or more prioritization rules; and (vi) report the one or more lack of compliance issues for the business facet to a user via a user interface.

In embodiments, example nine may be combined with example ten, wherein the compliance engine comprises a text analyzer configured to facilitate parsing of the one or more assets into a parsed asset.

In embodiments, examples nine or ten may be combined with example eleven, wherein the compliance engine comprises an inference engine configured to facilitate the analysis of the business facet.

In embodiments, examples, nine, ten, or eleven may be combined with example twelve, wherein an identified lack of compliance issue comprises a warning that one or more of the received workflow requirement, regulatory requirement, standard requirement, best practice requirement, and rule requirement are not met.

In embodiments, examples nine, ten, eleven, or twelve may be combined with example thirteen, wherein the processor is further configured to generate, based on the identified one or more lack of compliance issues, a recommendation for correcting a lack of compliance issue.

In embodiments, examples nine, ten, eleven, twelve, or thirteen may be combined with example fourteen, wherein the plurality of organizational assets comprises one or more of a user requirements, service initiation document, compatibility matrix, project plan, service delivery plan, product specification, customer feedback, service delivery plan, traceability matrix, supplier agreement, verification test, source code, purchase order, and checklist.

In embodiments, examples nine, ten, eleven, twelve, thirteen, or fourteen may be combined with example fifteen, wherein prioritizing multiple lack of compliance issues into a prioritized list based on one or more prioritization rules comprises weighing one or more of the lack of compliance issues.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. The figures showing features and ways of implementing various embodiments and are not to be construed as being limiting to other possible embodiments falling within the scope of the attached claims. Also, the drawings are not necessarily to scale, emphasis instead generally being placed upon illustrating the principles of the various embodiments.

FIG. 1 is a flowchart of a method for organizational compliance, in accordance with an embodiment.

FIG. 2 is a schematic representation of a compliance management system, in accordance with an embodiment.

FIG. 3 is a schematic representation of a compliance management system, in accordance with an embodiment.

FIG. 4 is a schematic representation of a compliance management system, in accordance with an embodiment.

FIG. 5 is a schematic representation of a compliance management system, in accordance with an embodiment.

FIG. 6 is a schematic representation of a compliance management system, in accordance with an embodiment.

FIG. 7 is a schematic representation of a compliance management system, in accordance with an embodiment.

### DETAILED DESCRIPTION OF EMBODIMENTS

The present disclosure describes various embodiments of a system and method configured to alert a user of a compliance management system to a lack of compliance issue. More generally, Applicant has recognized and appreciated that it would be beneficial to provide a method and system to manage or monitor an organization's compliance with a variety of compliance requirements. The compliance management system receives information about the organization's intangible assets, which can be one of a wide variety of different types of assets. The system receives a compliance requirement for a business facet of the organization. The business facet can be a product, process, sale, or any of a wide variety of business facets. The compliance requirement can be a workflow requirement, regulatory requirement, standard requirement, best practice requirement, and rule requirement for the business facet, among many other types of compliance requirements. The business facet utilizes one or more of the assets for completion. The system generates, from the received compliance requirement, one or more of a rule and a workflow. The system parses, using an asset parsing template of the compliance management system, each of the one or more assets into a parsed asset. The compliance management system uses a compliance engine to analyze the business facet, where analyzing comprises comparing the business facet to the received compliance requirement using (1) one or more of the parsed assets and (2) the rule and/or workflow to determine whether the business facet utilizes the asset according to the rule and/or workflow. The system identifies one or more lack of compliance issues based on the analysis. A lack of compliance issue comprises a determination by the compliance engine that the business asset fails to utilize the asset according to the rule and/or workflow and thus fails to satisfy the received compliance requirement. The system prioritizes the multiple lack of compliance issues into a prioritized list based on one or more prioritization rules, when multiple lack of compliance issues are identified, and reports the one or more lack of compliance issues for the business facet to a user via a user interface.

Accordingly, the methods and systems described or otherwise envisioned herein supports compliance efforts, provides accessibility to expert-level knowledge at all levels and locations of the organization, and enables valuable data generation from assets which is then available for further analysis and discovery. The methods and systems also lower error rates and result in higher quality outcomes in organizational processes such as design controls, product development, service and solutions, supplier management, procurement, and more. The methods and systems enable the definition of metrics and key performance indicators (KPIs) for monitoring at executive levels and project management offices, enables the assessment of the impact of a change before that change is implemented, enables basic to complex search querying mechanisms within multiple type of assets, and saves time on reviews, repetitive tasks, and asset classifications, among many other advantages.

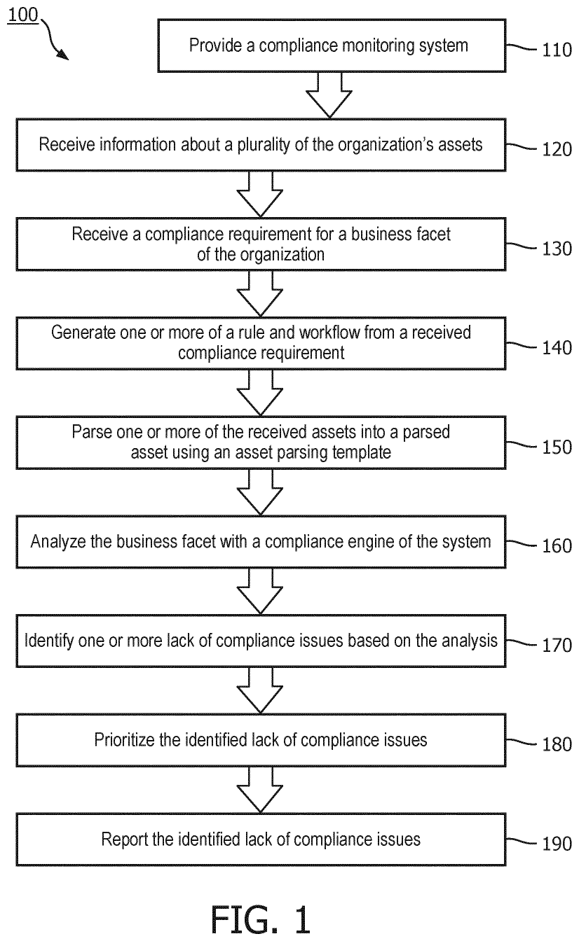

Referring to FIG. 1, in one embodiment, is a flowchart of a method 100 configured to manage or monitor an organization's compliance with a variety of compliance requirements using a compliance monitoring system. The methods described in connection with the figures are provided as examples only, and shall be understood not to limit the scope of the disclosure. The compliance monitoring system can be any of the systems described or otherwise envisioned herein. The organization for which monitoring is being performed can be any organization subject to any compliance requirement, as compliance requirements or elements are described or otherwise envisioned herein.

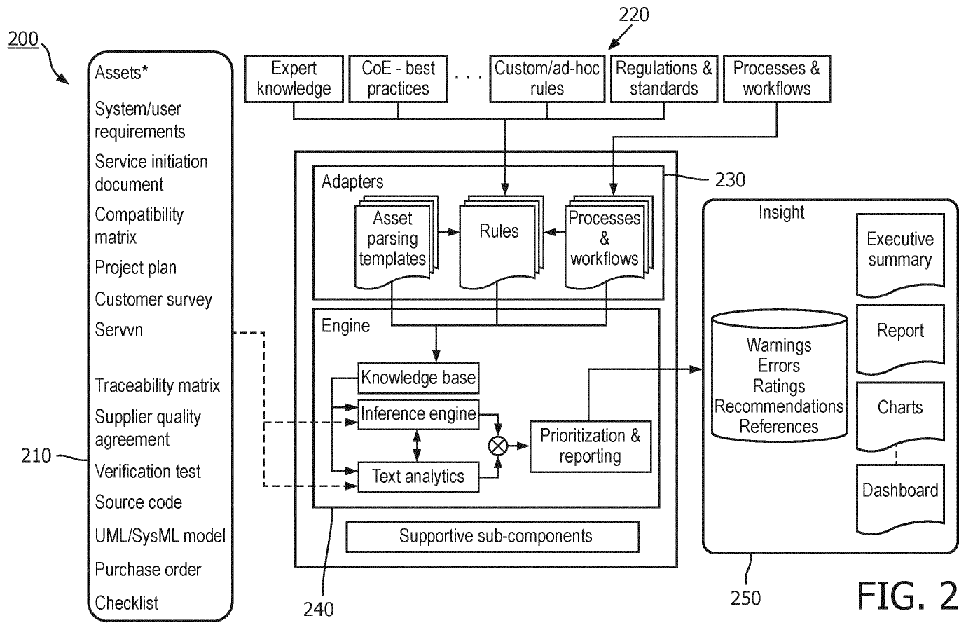

At step 110 of the method, according to an embodiment, a compliance monitoring system 200 is provided. Referring to an embodiment of a compliance monitoring system 200 as depicted in FIG. 2, for example, the system comprises one or more of a plurality of assets 210, compliance elements 220, one or more adapters 230, one or more engine elements 240, and insight 250. It will be understood that FIG. 2 constitutes, in some respects, an abstraction and that the actual organization of the components of the system 200 may be different and more complex than illustrated.

At step 120 of the method, according to an embodiment, the system receives, accesses or is otherwise provided with information about one or more of the organization's assets. An asset can be anything that a compliance monitoring system might need to monitor or evaluate compliance, and that the system can access. For example, assets can be documents, spreadsheets, databases, or any other element that could be used by the compliance monitoring system to monitor or evaluate compliance. Some non-limiting examples of assets include system or user requirements, service initiation documents, compatibility matrices, project plans, service delivery plans, product specifications, customer surveys or responses or complaints, service delivery plans, traceability matrices, supplier agreements, verification tests, source code, UML/SysML models, purchase orders, checklist, or any other asset.

According to an embodiment, receiving, accessing, or being provided with information about one or more of the organization's assets could comprise accessing a digital document or a database within the compliance monitoring system, or accessing an asset in an associated or remote database. It could also comprise digitization of a document. For example, receiving information about an asset could comprise receiving a scanned or otherwise digitized copy of a checklist, among many other examples. The asset can be stored in memory or any other data structure for immediate and/or later use by the system.

At step 130 of the method, the compliance monitoring system receives a compliance requirement for a business facet of the organization. A business facet is anything for which compliance by the organization is necessary, and which utilizes one or more of the assets for completion. For example, a business facet could be a product, a sale, customer service, a process performed by the organization, or anything else the organization does, as described or otherwise envisioned herein. A compliance requirement can be, for example, one or more of expert knowledge, a workflow requirement, regulatory requirement, standard requirement, best practice requirement, and/or rule requirement for the business facet, among other possible compliance requirements. A compliance requirement can be stored in memory or any other data structure for immediate and/or later use by the system.

At step 140 of the method, the compliance monitoring system generates, from the received compliance requirement, one or more of a rule and/or a workflow. According to an embodiment, compliance monitoring system 200 comprises one or more adaptors configured to generate a rule or a workflow from a compliance requirement. An adaptor converts written, digital, or mental information into a formal data structure that can be utilized by other elements of the compliance monitoring system. According to an embodiment, the system may comprise a user interface that interacts with or otherwise provides or modifies an adaptor, which can be implemented as, for example, a web application or a plug-in to an existing application.

According to an embodiment, an adaptor of the system formalizes a process or workflow using standardized notation, such as business process modelling notation (BPMN), although other standardized structures or formats are possible. In highly regulated environments, processes are well-documented and well-defined, and they may have already been modelled with BPMN or a similar formal notation. These models bring substantial value during relational analysis, such as finding missing dependencies, searching logical errors, giving recommendations about the next step, knowing what is necessary from each asset input for evaluation, and more. These models can also be referenced and used in a rule as discussed below.

According to an embodiment, an adaptor of the system defines or otherwise formalizes one or more rules utilized by the organization. Rules define how a compliance analysis can run, rules can be fuzzy, and can range from very basic to highly complex. Rules will be utilized by the system to perform a compliance analysis. Common sources of rules are, for example, expert knowledge, standards, regulations, and best practices, among other sources.

After rules are defined, they can be made available corporate-wide and if required some rules can be enforced to be passed before proceeding. User of the system can also define their own rules to make analysis or assessment. As an example, a document entitled “Good Documentation Practices” can be converted to rules as part of a web application. Users can validate their document against “Good Documentation Practices” before submitting for approval.

Once a workflow, process, or rule is generated, it can be stored in a compliance database or any other data structure for immediate and/or later use by the system.

At step 150 of the method, the compliance monitoring system parses one or more of the received assets into a parsed asset using an asset parsing template. According to an embodiment, an asset parsing template is an adaptor of the compliance monitoring system. An asset parsing template defines how a certain asset will be parsed by the system. For example, it can define how a digital version of a document such as a word processing document is digested or otherwise parsed by the system. For example, each read element of an asset may have an assigned ID which can be referenced by a rule, processor, or workflow.

As an example, a word template may be filled by a person by hand or digitally, and the system may be designed to parse a section entitled “Software and Tools” that is planned for Service Delivery and later use for analysis. It is known by the asset parsing template—either through design, programming, direction, or machine learning—that “Software and Tools” will be under Section 3.3 of the document. The asset parsing template will help the system to convert this list to a software table.

Once an asset is parsed, the extracted or parsed information may be stored in a database or any other data structure for immediate and/or later use by the system.

At step 160 of the method, the system analyzes the business facet with a compliance engine of the compliance monitoring system. According to an embodiment, analyzing the business facet comprises comparing the business facet to the received compliance requirement using (1) one or more of the parsed assets and (2) the rule and/or workflow to determine whether the business facet utilizes the asset according to the rule and/or workflow.

According to an embodiment, a compliance engine is any element that utilizes the output of an adaptor, and an asset input, to perform a compliance analysis. In other words, given the assets as input, a compliance engine runs the requested rules and/or workflow/process while also using the asset parsing templates.

An example of a compliance engine is a knowledge base. The knowledge base comprises all the information generated by the adaptors. It can be, for example, a relational database which empowers the inference engine and text analytics components discussed below. The knowledge base comprises, for example, information about assets (i.e. documents, source code, UML models, etc.) to use and how to work on the input data for any analysis.

Another example of a compliance engine is an inference engine. The inference engine interprets given assets based on the knowledge base facts and rules. The inference engine can generate insight directly to the user and/or interact with text analytics component depending on the analysis being run.

Another example of a compliance engine is a text analytics component. The text analytics component runs text analytics algorithms required by the requested analysis (e.g. ambiguity in text, classification of text, semantic analysis, etc.). Text analytics and text mining can be utilized interchangeably in this context. The text analytics component can generate insight directly to the user and/or interact with the interference engine component depending on the analysis being run. According to an embodiment, the system is able to extend its algorithm libraries and make new analyses available. Adding new algorithms may require updating the rules notation as well.

At step 170 of the method, the compliance management system identifies one or more lack of compliance issues based on the analysis. According to an embodiment, a lack of compliance issue comprises a determination by the compliance engine that the business asset fails to utilize the asset according to the rule and/or workflow and thus fails to satisfy the received compliance requirement.

At step 180 of the method, the system the compliance management system prioritizes lack of compliance issues into a prioritized list based on one or more prioritization rules, when multiple lack of compliance issues are identified in step 170 of the method. According to an embodiment, each rule outcome from the compliance engine has a level and/or weight associated with it. For example, a level can be thought of as an error, warning, and/or recommendation. A weight can be thought of as the severity of the outcome. Levels and weights can be predetermined or preprogrammed by a user of the system. These two parameters can thus be used to prioritize the insight generated. After prioritization is completed, necessary reporting steps will be followed to pass the insight for visualization.

At step 190 of the method, the compliance management system reports the one or more lack of compliance issues for the business facet to a user via a user interface. The one or more lack of compliance issues, which can be a warning, an error, a rating, a recommendation, a reference, and/or any other reported element, can also be stored in a database. According to an embodiment, the generated insight can be visualized in any form desired, such as a report, dashboard, checklist, chart, and/or any other format.

Thus, according to one embodiment of the compliance management system, the system parses assets according to an asset parsing template. As an example, the system may parse a Service Delivery Plan using a template and create a table from “Section 3.3—Software and Tools” for a subsequent analysis step. The system utilizes dependencies of documents, states, and tasks in a workflow or process in the analysis. For example, analyzing what kind of documents are required to be completed and what is necessary to pass the next step. The system defines basic to complex rules including references to other artifacts. For example, the system may list all the System Requirements from a specific document, divide the number of test cases of each requirement by the text length of requirement, and pass the result as a table. The system runs text analytics on assets based on the defined rules. For example, the system can parse the documented requirements and score against ambiguity in each requirement, or, parse the customer complaints and classify accordingly. The system feeds information between the text analytics and inference engine results. For example, a set of documents are first analyzed by running text analytics and then the results can be used to filter out and create a smaller subset of documents for further analysis. The system generates prioritized results with recommendations and references. For example, a person working on his feature can submit his peer review before sending to peers and get recommendations with hyperlinks to work instructions.

There are many areas of an organization in which a compliance management system can be applied. For example, the system could be utilized in the area of professional services and solutions generation, efforts regarding customer complaints, assessing regulatory change, product design and verification, and many, many other areas. In addition, many different professionals within the organization may benefit from the application of a compliance management system. As just a few non-limiting examples, executives, PMO, Q&R group, sales group, and on-boarding professionals are groups which can benefit from the solution.

According to an embodiment, the compliance management system is meant to be a decision support and assistance system. It will require a judgement from the user evaluating the resulting insights. The user will have a prioritized list of errors and warnings, recommendations, references to related assets, etc. which will eventually enhance the decision making process. However, if the rule relies directly on a criterion which can be automated with a high confidence interval, then the solution can be configured to reject the asset automatically. This mechanism could be similar web interface running input validation which forces several input fields to be entered before proceeding. For example, the solution can be configured to reject the asset automatically where a date does not comply with a preferred practice, where a new asset references an obsolete document, where there is a non-classified complaint document, and many more examples. The system enables the definition of KPIs on a subset of assets and enables monitoring of them on a periodic basis. The system can assess the impact of a change such as a change in best practices, a change in regulations, and other changes. The system can discover patterns, and can gather insights from customer surveys or complaints.

### Embodiment 1

This example is provided to identify an application of one particular embodiment of the compliance management system, and thus is a non-limiting example. The compliance management system can be any of the systems described or otherwise envisioned herein.

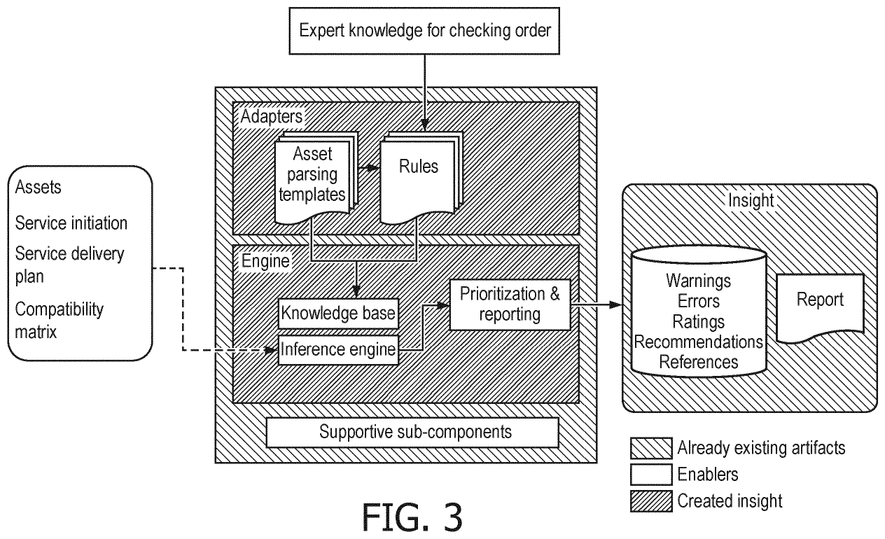

Referring to FIG. 3 is one implementation of an embodiment of the compliance management system. In this embodiment, the system is being utilized to identify and address problems from customer surveys and interviews. In particular, the system is being used to address the issue of change orders being made before implementation due to a non-compliance issue. This can increase costs, cause customer frustration and complaints, and give the impression that the organization does not know what it installed in the past.

The orders are planned, and some expert realizes that change orders are required, just before implementation. A basic and effective approach to minimize such issues seems like using a compatibility matrix and checklists. This can be very quickly achieved and automated by the compliance management system. In this scenario, the compliance management system structure would seem as in FIG. 3. An expert creates the rules how to minimize such issues. The field person creating the order submits the assets to the engine. The engine runs the rules on the filled service templates, and also checks against most recent compatibility matrices to see whether any software, hardware, or service conflicts with the offer, before committing to the customer. This eliminates the need for change orders.

### Embodiment 2

This example is provided to identify an application of one particular embodiment of the compliance management system, and thus is a non-limiting example. The compliance management system can be any of the systems described or otherwise envisioned herein.

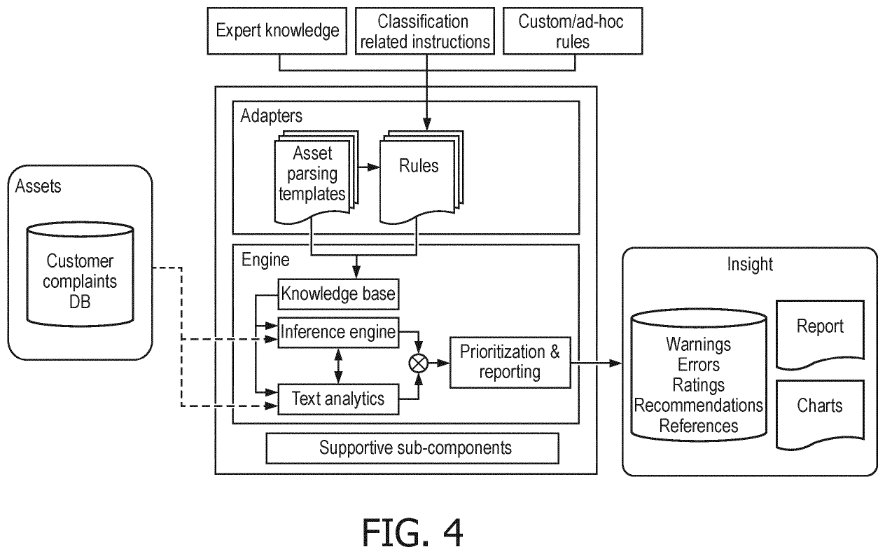

Referring to FIG. 4 is one implementation of an embodiment of the compliance management system. In this embodiment, the system is being utilized for customer complaints classification and categorization. If there are too many customer complaints, there may not be enough representatives, analysts, or experts to process the complaints. The compliance management system can be utilized to classify and categorize the complaints, using for example the text analytics component. FIG. 4 depicts a components diagram based on this scenario. Here, the system also comprises “Custom/Ad-Hoc Rules” which means a Q&R professional has defined custom rules to optimize the results or try a different analysis approach. The other analysis criteria come from “Expert Knowledge” and another document (“Classification Related Instructions”) reflecting standards how to classify and categorize complaints. The assets are being read from a customer complaints database.

### Embodiment 3

This example is provided to identify an application of one particular embodiment of the compliance management system, and thus is a non-limiting example. The compliance management system can be any of the systems described or otherwise envisioned herein.

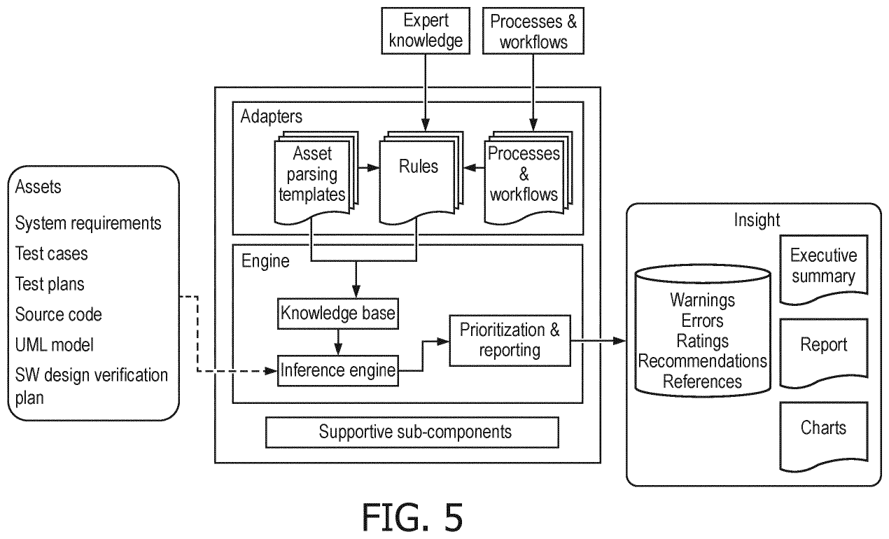

Referring to FIG. 5 is one implementation of an embodiment of the compliance management system. In this embodiment, the system is being utilized for design verification. During design verification, it may be discovered, for example, that a new product feature causes a bug or other design issue in a product. When a process is complicated, it requires input from different people, based on manual reviews, etc., and thus it increases the probability of making a mistake and introducing this problem in the field.

In this example, all the related assets getting assistance from the system are input, which test cases to plan for the verification. The analysis uses source code repositories, UML models, system requirements, test cases, test plans, and the first version of software design verification plan created, as an example. Using asset parsing templates, the system can parse and interpret all the given assets. According to an embodiment, the system can compare changes to the product since the last release, compare changes in different asset types, relate different types to each other using workflow and process models, use the information in the given verification plan, and use the given expert knowledge for further querying and analysis, among other aspects.

### Embodiment 4

This example is provided to identify an application of one particular embodiment of the compliance management system, and thus is a non-limiting example. The compliance management system can be any of the systems described or otherwise envisioned herein.

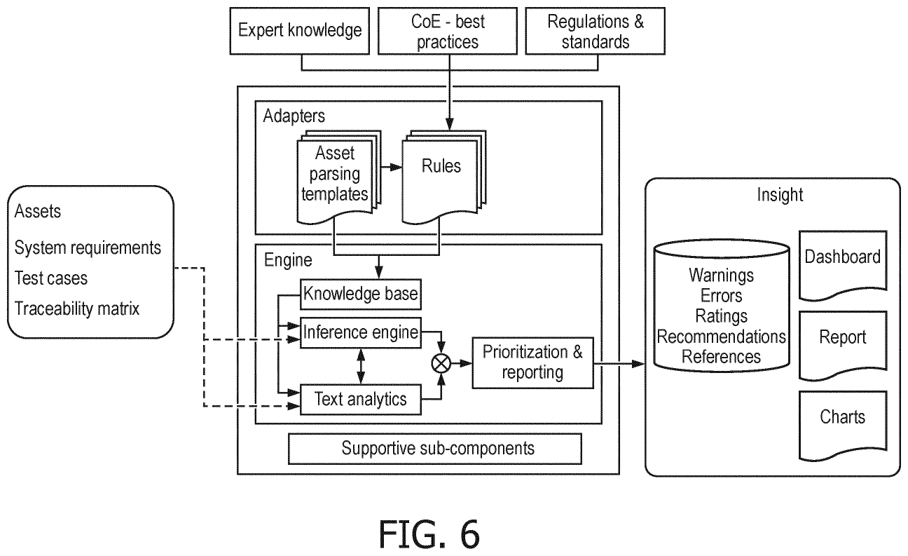

Referring to FIG. 6 is one implementation of an embodiment of the compliance management system. In this embodiment, the system is being utilized for compliance tracking by a project management office or officer. According to an embodiment, the PMO officer looks for a traceability matrix for system requirements and test cases. The PMO officer sees that there is no problem and relationships all seem to be fine on the matrix. However, the PMO officer would like to analyze further the contents of the requirements and test cases, wanting to determine whether tests are designed according to company's best practices, and whether requirements are documented. The PMO Officer also want to see whether standards and regulation related requirements are mentioned in the system requirements. Lastly, the PMO officer's final goal is to prioritize any issues.

According to an embodiment, FIG. 6 shows the components that can be utilized in the scenario. For example, the analysis can include determine requirements with an ambiguity score greater than a defined level, determine test cases which have a single test step but verifies multiple requirements, analyze the relation between the requirement text length and number of tests corresponding, and sort the requirements which are a certain quality score level, check whether the requirements' text is consistent with its title, and check test cases referencing obsolete products, among many others. According to an embodiment, the results can be used to generate a dashboard, and then the same analysis can be run periodically to determine how the project team is improving prioritized quality related tasks over time.

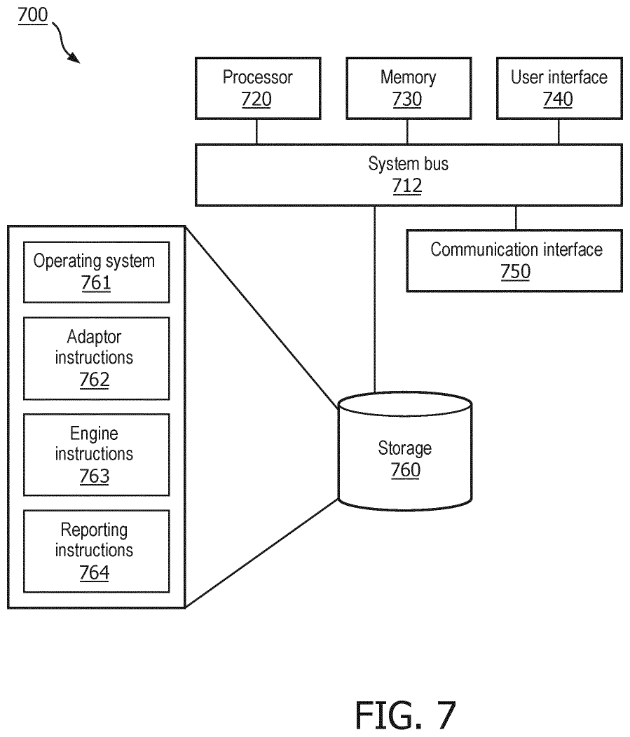

Referring to FIG. 7, in one embodiment, is a schematic representation of a compliance management system 700. System 700 may be any of the systems described or otherwise envisioned herein, and may comprise any of the components described or otherwise envisioned herein. According to an embodiment, system 700 comprises one or more of a processor 720, memory 730, user interface 740, communications interface 750, and storage 760, interconnected via one or more system buses 712. It will be understood that FIG. 7 constitutes, in some respects, an abstraction and that the actual organization of the components of the system 700 may be different and more complex than illustrated.

According to an embodiment, system 700 comprises a processor 720 capable of executing instructions stored in memory 730 or storage 760 or otherwise processing data to, for example, perform one or more steps of the method. Processor 720 may be formed of one or multiple modules. Processor 720 may take any suitable form, including but not limited to a microprocessor, microcontroller, multiple microcontrollers, circuitry, field programmable gate array (FPGA), application-specific integrated circuit (ASIC), a single processor, or plural processors.

Memory 730 can take any suitable form, including a non-volatile memory and/or RAM. The memory 730 may include various memories such as, for example L1, L2, or L3 cache or system memory. As such, the memory 730 may include static random access memory (SRAM), dynamic RAM (DRAM), flash memory, read only memory (ROM), or other similar memory devices. The memory can store, among other things, an operating system. The RAM is used by the processor for the temporary storage of data. According to an embodiment, an operating system may contain code which, when executed by the processor, controls operation of one or more components of system 700. It will be apparent that, in embodiments where the processor implements one or more of the functions described herein in hardware, the software described as corresponding to such functionality in other embodiments may be omitted.

User interface 740 may include one or more devices for enabling communication with a user. The user interface can be any device or system that allows information to be conveyed and/or received, and may include a display, a mouse, and/or a keyboard for receiving user commands. In some embodiments, user interface 740 may include a command line interface or graphical user interface that may be presented to a remote terminal via communication interface 750. The user interface may be located with one or more other components of the system, or may located remote from the system and in communication via a wired and/or wireless communications network.

Communication interface 750 may include one or more devices for enabling communication with other hardware devices. For example, communication interface 750 may include a network interface card (NIC) configured to communicate according to the Ethernet protocol. Additionally, communication interface 750 may implement a TCP/IP stack for communication according to the TCP/IP protocols. Various alternative or additional hardware or configurations for communication interface 750 will be apparent.

Storage 760 may include one or more machine-readable storage media such as read-only memory (ROM), random-access memory (RAM), magnetic disk storage media, optical storage media, flash-memory devices, or similar storage media. In various embodiments, storage 760 may store instructions for execution by processor 720 or data upon which processor 720 may operate. For example, storage 760 may store an operating system 761 for controlling various operations of system 700.

It will be apparent that various information described as stored in storage 760 may be additionally or alternatively stored in memory 730. In this respect, memory 730 may also be considered to constitute a storage device and storage 760 may be considered a memory. Various other arrangements will be apparent. Further, memory 730 and storage 760 may both be considered to be non-transitory machine-readable media. As used herein, the term non-transitory will be understood to exclude transitory signals but to include all forms of storage, including both volatile and non-volatile memories.

While system 700 is shown as including one of each described component, the various components may be duplicated in various embodiments. For example, processor 720 may include multiple microprocessors that are configured to independently execute the methods described herein or are configured to perform steps or subroutines of the methods described herein such that the multiple processors cooperate to achieve the functionality described herein. Further, where one or more components of system 700 is implemented in a cloud computing system, the various hardware components may belong to separate physical systems. For example, processor 720 may include a first processor in a first server and a second processor in a second server. Many other variations and configurations are possible.

According to an embodiment, storage 760 of system 700 may store one or more algorithms, modules, and/or instructions to carry out one or more functions or steps of the methods described or otherwise envisioned herein. For example, processor 720 may comprise, among other instructions, adaptor instructions 762, engine instructions 763, and reporting instructions 764.

According to an embodiment, adaptor instructions 762 direct the system to generate a rule or a workflow from a compliance requirement. An adaptor converts written, digital, or mental information into a formal data structure that can be utilized by other elements of the compliance monitoring system. According to an embodiment, the system may comprise a user interface that interacts with or otherwise provides or modifies an adaptor, which can be implemented as, for example, a web application or a plug-in to an existing application. According to an embodiment, an adaptor of the system formalizes a process or workflow using standardized notation, such as business process modelling notation (BPMN), although other standardized structures or formats are possible. According to an embodiment, an adaptor of the system defines or otherwise formalizes one or more rules utilized by the organization.

According to an embodiment, engine instructions 763 direct the system to utilize the output of an adaptor, and an asset input, to perform a compliance analysis. Given the assets as input, a compliance engine runs the requested rules and/or workflow/process while also using the asset parsing templates. Examples of compliance engines include a knowledge base, an inference engine, and a text analytics component.

According to an embodiment, reporting instructions 764 direct the system to report lack of compliance issues for the business facet to a user via a user interface. The one or more lack of compliance issues, which can be a warning, an error, a rating, a recommendation, a reference, and/or any other reported element, can also be stored in a database. According to an embodiment, the generated insight can be visualized in any form desired, such as a report, dashboard, checklist, chart, and/or any other format. The system may provide the report via any mechanism for providing a report, including but not limited to a visual display, an audible report, a text report, an email, a page, or any other method of reporting.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A method for managing an organization's compliance using a compliance management system, comprising:
receiving information about one or more of the organization's assets;
receiving a compliance requirement for a business facet of the organization, wherein the compliance requirement comprises one or more of a workflow requirement, regulatory requirement, standard requirement, best practice requirement, and rule requirement for the business facet, and wherein the business facet utilizes one or more of the assets for completion;
generating, from the received compliance requirement, one or more of a rule and a workflow;
parsing, using an asset parsing template of the compliance management system, each of the one or more assets into a parsed asset;
analyzing, using a compliance engine, the business facet, wherein analyzing comprises comparing the business facet to the received compliance requirement using (1) one or more of the parsed assets and (2) the rule and/or workflow to determine whether the business facet utilizes the asset according to the rule and/or workflow;
identifying one or more lack of compliance issues based on the analysis, wherein a lack of compliance issue comprises a determination by the compliance engine that the business asset fails to utilize the asset according to the rule and/or workflow and thus fails to satisfy the received compliance requirement;
prioritizing, when multiple lack of compliance issues are identified, the multiple lack of compliance issues into a prioritized list based on one or more prioritization rules; and
reporting the one or more lack of compliance issues for the business facet to a user via a user interface.

2. The method of claim 1, wherein the compliance engine comprises a text analyzer configured to facilitate parsing of the one or more assets into a parsed asset.

3. The method of claim 1, wherein the compliance engine comprises an inference engine configured to facilitate the analysis of the business facet.

4. The method according to claim 1, wherein an identified lack of compliance issue comprises a warning that one or more of the received workflow requirement, regulatory requirement, standard requirement, best practice requirement, and rule requirement are not met.

5. The method according to claim 1, wherein the method further comprises the step of generating, based on the identified one or more lack of compliance issues, a recommendation for correcting a lack of compliance issue.

6. The method according to claim 1, wherein the asset comprises one or more of a user requirements, service initiation document, compatibility matrix, project plan, service delivery plan, product specification, customer feedback, service delivery plan, traceability matrix, supplier agreement, verification test, source code, purchase order, and checklist.

7. The method according to claim 1, wherein the compliance requirements comprise one or more user-defined rules.

8. The method according to claim 1, wherein prioritizing multiple lack of compliance issues into a prioritized list based on one or more prioritization rules comprises weighing one or more of the lack of compliance issues.

9. A compliance management system for an organization, comprising:
a plurality of organizational assets;
a plurality of compliance requirements for a business facet of the organization, wherein the compliance requirement comprises one or more of a workflow requirement, regulatory requirement, standard requirement, best practice requirement, and rule requirement for the business facet, and wherein the business facet utilizes one or more of the assets for completion; and
a processor configured to: (i) generate, from the received compliance requirement, one or more of a rule and a workflow; (ii) parse, using an asset parsing template of the compliance management system, each of the one or more assets into a parsed asset; (iii) analyze, using a compliance engine, the business facet, wherein analyzing comprises comparing the business facet to the received compliance requirement using (1) one or more of the parsed assets and (2) the rule and/or workflow to determine whether the business facet utilizes the asset according to the rule and/or workflow; (iv) identify one or more lack of compliance issues based on the analysis, wherein a lack of compliance issue comprises a determination by the compliance engine that the business asset fails to utilize the asset according to the rule and/or workflow and thus fails to satisfy the received compliance requirement; (v) prioritize, when multiple lack of compliance issues are identified, the multiple lack of compliance issues into a prioritized list based on one or more prioritization rules; and (vi) report the one or more lack of compliance issues for the business facet to a user via a user interface.

10. The system of claim 9, wherein the compliance engine comprises a text analyzer configured to facilitate parsing of the one or more assets into a parsed asset.

11. The system of claim 9, wherein the compliance engine comprises an inference engine configured to facilitate the analysis of the business facet.

12. The system according to claim 9, wherein an identified lack of compliance issue comprises a warning that one or more of the received workflow requirement, regulatory requirement, standard requirement, best practice requirement, and rule requirement are not met.

13. The system according to claim 9, wherein the processor is further configured to generate, based on the identified one or more lack of compliance issues, a recommendation for correcting a lack of compliance issue.

14. The system according to claim 9, wherein the plurality of organizational assets comprises one or more of a user requirements, service initiation document, compatibility matrix, project plan, service delivery plan, product specification, customer feedback, service delivery plan, traceability matrix, supplier agreement, verification test, source code, purchase order, and checklist.

15. The system according to claim 9, wherein prioritizing multiple lack of compliance issues into a prioritized list based on one or more prioritization rules comprises weighing one or more of the lack of compliance issues.
